(19) United States
(12) Patent Application Publication
(10) Pub. No.: US 2022/0036482 A1
(43) Pub. Date: Feb. 3, 2022

(54) SYSTEMS AND METHODS UTILIZING REAL DATA-DRIVEN MODELS FOR PREDICTING AND OPTIMIZING CROP PRODUCTION

(71) Applicant: University of South Florida, Tampa, FL (US)

(72) Inventors: Chris Peter Tsokos, Tampa, FL (US); Lohuwa Mamudu, Tampa, FL (US)

(21) Appl. No.: 17/392,047

(22) Filed: Aug. 2, 2021

Related U.S. Application Data
(60) Provisional application No. 63/059,304, filed on Jul. 31, 2020.

(51) Int. Cl. G06Q 50/02; G06Q 30/02; G06Q 10/04; G06N 7/00

(52) U.S. Cl. CPC G06Q 50/02; G06N 7/005; G06Q 10/04; G06Q 30/0205

(57) ABSTRACT

A data-driven model to predict the returns of the production of corn in the U.S. is described. In one example, the model can account for 25 elements or factors presumed by the U.S. department of agriculture (USDA) to be contributing to the returns from corn production in the US. The model is designed on the basis of a number of parameters, including the selection of a significant set of the 25 factors, the extent or percentage of contribution of each factor, the extent of contribution to unknown factors, the identification of which of the significant factors are interacting, and others. In one example, 7 out of the 25 factors were found to be statistically significant, and 6 interaction terms were identified. The proposed model accurately predicts the returns from corn production in the U.S. with 98.22% accuracy.

### CROSS REFERENCE TO RELATED APPLICATIONS

This application claims priority to U.S. Prov. Appl. Ser. No. 63/059,304, filed on Jul. 31, 202, the entire content of which is incorporated herein by reference.

### BACKGROUND

The production of crops plays a major role in the economics of various countries, including the United States, through a variety of uses and industries including in feed/animal agriculture as well as human food consumption, biofuel production, and other industries. For example, the U.S. is currently the world's leading producer of corn, with corn serving many purposes in the economics of ethanol production, beverage alcohol production, livestock feeds, cereals, sweeteners, and other consumables.

Crops are also often considered commodities, and thus impact various investments and financial markets as well. Likewise, various governmental and institutional bodies interact with crop production in a variety of ways, through taxes, subsidies, tariffs, and the like.

Given the importance of crops to such a variety of economic considerations, it would be helpful if a more precise system and method existed for predicting crop production (on both large and small scales) and prediction of how changing important economic inputs to crop production would affect production and returns.

### BRIEF DESCRIPTION OF THE DRAWINGS

The patent or patent application file contains at least one drawing in color. Copies of this patent or patent application publication with color drawings will be provided by the Office upon request and payment of the necessary fee.

For a more complete understanding of the embodiments and the advantages thereof, reference is now made to the following description, in conjunction with the accompanying figures briefly described as follows:

FIG. 1 illustrates corn production by county in the U.S.

FIG. 2 illustrates an example relationship between marginal revenue and marginal cost according to various examples described herein.

FIG. 3 illustrates a time series of the returns from corn production in the U.S. from 1975-2018 according to various examples described herein.

FIG. 4 illustrates a histogram showing the probability distribution of the returns on corn production in the U.S. from 1975-2018 according to various examples described herein.

FIG. 5 illustrates a correlation matrix of response and attributable variables according to various examples described herein.

FIG. 6 illustrates a plot of normal distribution of residuals according to various examples described herein.

FIG. 7 illustrates plots assessing the linearity of the models proposed herein according to various examples described herein.

FIG. 8 illustrates plots assessing the normal probability distribution assumption of the proposed model according to various examples described herein.

FIG. 9 illustrates a plot assessing homoscedasticity assumption of the proposed model according to various examples described herein.

FIG. 10 illustrates a chart to assess the accuracy of the models proposed herein according to various examples described herein.

FIG. 11 illustrates a computing environment for the generation of a model according to various examples described herein.

FIG. 12 illustrates an example schematic block diagram of a computing device for the computing environment shown in FIG. 11 according to various embodiments described herein.

The drawings illustrate only example embodiments and are therefore not to be considered limiting of the scope of the embodiments described herein, as other embodiments are within the scope of the disclosure.

### SUMMARY

Various systems and methods are disclosed herein for overcoming the disadvantages and limitations of the prior art. The advantages and features described herein can be realized via the practical deployment or implementation of different combinations of components or steps, as further described below.

For example, in one aspect, a system is provided for generating predictions of crop returns. The system may comprise a communications connection; at least one processor coupled to the communications connection; and a memory device having stored thereon a set of computer-readable instructions which, when executed by the at least one processor, cause the at least one processor to: identify a set of initial factors contributing to returns from production of a given crop in a given geography; obtain data for the initial factors and historic returns from production of the given crop in the given geography, and assess statistical reliability of the production returns data; assess linearity of correlation between each of the set of initial factors and historic returns; assess multicollinearity of each of the set of initial factors and historic returns; transform the historic returns data, and fit the initial factors to the transformed historic returns data, to employ a step-by-step backward elimination model selection, to select significant contributing factors and interactions of factors to form a predictive model; using the predictive model, process agricultural data, operational cost data, and economic data for the given crop for a given farming enterprise growing the given crop within the given geography; and return to a user a prediction of production returns for the given crop under the farming enterprise's supplied data.

In another aspect, various embodiments may be implemented as systems for analyzing agricultural production. Such systems may comprise a communications connection; at least one processor coupled to the communications connection; and a memory device having stored thereon a set of computer-readable instructions which, when executed by the at least one processor, cause the at least one processor to: receive a request from a user for a predictive analysis of agricultural production of a given crop for a given geography; process agricultural data, operational cost data, and economic data for the given crop and given geography according to a model for agricultural production; return to the user a prediction of production and at least one recommendation for increasing or decreasing resources invested in at least one contributing factor to the production prediction, the contributing factors comprising at least one of: opportunity cost of land; cost of fuel, lube and electricity; cost of custom services; value of primary crop product; cost of fertilizer; combination of fertilizer cost and crop price; value of operating capital; cost of hired labor; combination of fertilizer cost and farm enterprise size; combination of value of primary crop product and price; combination of opportunity cost of land and price; combination of fertilizer cost and variable cost expenses; and combination of cost of repairs and value of operating capital.

In another aspect, a method may be provided for optimizing operations of a farming enterprise, comprising: identifying first value data for a plurality of isolated factors contributing to crop production returns; identifying second value data for a plurality of interaction factors contributing to crop production returns; sending the first value data and the second value data to a remote computing environment; causing an optimization analysis to be performed by the remote computing environment using the first value data and the second value data, to identify at least one optimization factor to be increased or decreased in order to maximize the crop production returns; and increasing or decreasing the farming enterprise's allocation of resources to the at least one optimization factor.

### DETAILED DESCRIPTION

The production of crops (such as corn, also known as “maize”) plays a major role in the economics of the United States. Planning rationally and judiciously in distributing economic resources effectively and efficiently can result in maximizing the returns from crop production.

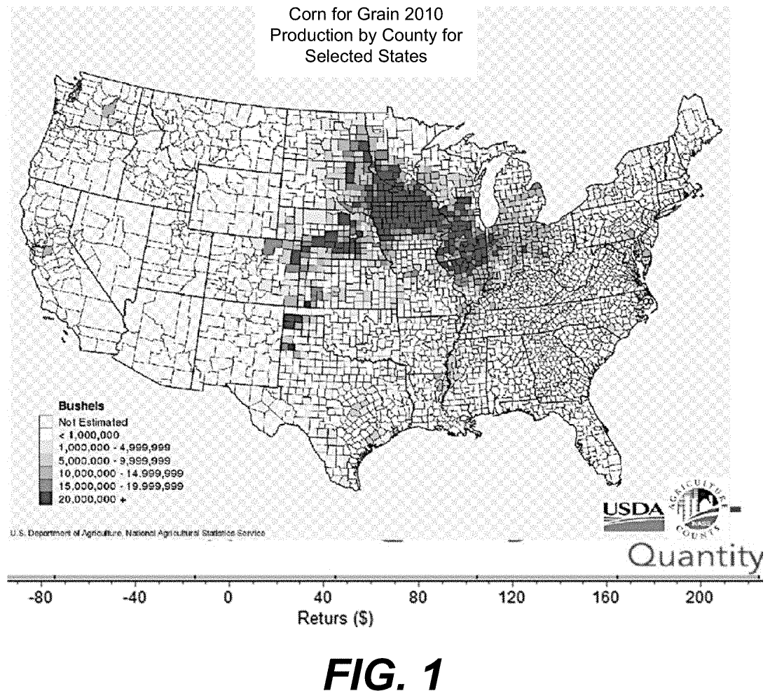

For example, the U.S. is the largest corn producer in the world, utilizing 96,000,000 acres of land reserved for corn production. Corn is the most widely produced crop and feed grain in the U.S., accounting for over 95% of total production and use. Corn has a wide range of usefulness to both humans and animals (especially livestock). Among these are food and industrial products including cereal, alcohol, sweeteners, and byproduct feeds, and energy ingredient in livestock feed. In 2017, the U.S. grew 15.1 billion bushels of corn production, and Iowa is the largest producer of corn, producing 2.7 billion of those bushels. As shown in FIG. 1, U.S. corn growth is dominated by west/north central Iowa and east central Illinois, with approximately 13% of its annual yield exported.

It is reported for the year 2013-2014 that the total production of corn in the US was 13.016 billion bushels, of which the major use is for manufacture of ethanol and its co-product (Distillers' Dried Grains with Solubles) accounting for 37% (27%+10%), or 4,845 million bushels (3,552+1,293). Even the maize cobs, which are mostly a by-product, can be used as a biomass fuel source in stoves. For the years 1950-1959, the final estimated production was 3 billion bushels, and the recent years production is 9 billion bushels per year.

Farmers in the U.S. obtain 20% more corn per acre than in any other part of the world. Most U.S. corn production is based on irrigation and implementing soil conservation measures, which have reduced soil erosion. Experts believe that Iowa has become the world's largest producer of corn and the home of most of the world's finest corn production farmers because it holds the most fertile topsoil on the planet.

There is a high acceleration of corn demand in the U.S. The average American spends $267 annually on purchasing corn. The overwhelming demand for corn is partly due to the use of maize for biofuel production. In the U.S., food prices are widely affected by the cost of transportation, production, and marketing. As a result, the use of maize as a biofuel has shifted farmers from the production of other food crops to maize production, so as to meet the growing demand for maize and increase their profitability. This has resulted in a decrease in the supply of other food crops and increases corn prices.

The value of corn depends on the number of bushels, the quality of the corn, and varies among location. The value of corn in the U.S. is continuously increasing, largely due to the higher demand and reliance on corn. In general, factors such as weather and economic predicaments/crisis may influence the value or price of corn produced at a particular period, which in turn influences the returns/profit made from corn production. Maize is usually bought and sold by investors and price speculators as a tradable commodity using corn futures contracts, which directly/indirectly affects the returns earned on maize production.

The returns on corn production may be negative, positive, or zero. Negative returns, also known as net loss, occur when the cost of the corn production exceeds the revenue/income earned. Positive returns occur when the revenue earned exceeds the cost of production of the corn. Zero returns, in other words, known as “break-even,” occurs when the cost equals the revenue earned. Thus, the return of production is mainly influenced by cost and revenue.

The cost of production, often called the “Total Cost (TC)” plays a major role in the returns from crop production. TC consists of the fixed cost (FC), including the cost incurred on fixed factors/inputs such as capital, equipment, farmland, etc., and the variable cost (VC) the cost incurred on variable factors such as cost of labor, farm inputs, etc. In production, fixed factors remain unchanged as output changes, but variable inputs or factors change with varying units of output. TC is influenced by marginal cost (MC) (the addition to TC from producing one more unit of product) of production.

The revenue referred to as “Total Revenue (TR)” is the earnings/income often from the sale of the crop. The TR of production is also influenced by the marginal revenue (MR) (the addition to TR from the sale of one more unit of product). TR largely depends on the supply, demand, and market value or price of the crop at the time of sales. In 2017 and 2018, U.S. domestic demand for corn increased due to demand for the production of ethanol and feed. In general, if the supply of a crop remains unchanged, an increase in demand creates a natural shortage, causing the value of the crop to increase in the short run. On the other hand, if the supply of a crop remains the same, a decrease in demand creates excess supply or natural surplus, leading to a fall in the price of a crop in the short run. Various governmental agencies and subsidies exist to aid farmers, and the farming industry, in navigating these natural fluctuations.

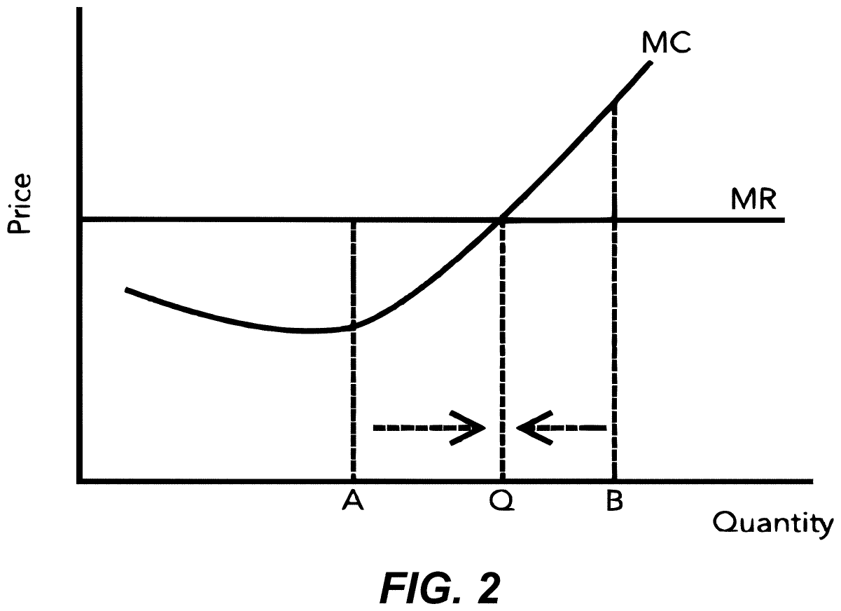

The profitability of agriculture production, and corn in particular, is often said to be determined by MC and MR. A firm is said to make a profit if MR>MC, losing if MR<MC, and at the profit-maximizing stage if MR=MC. FIG. 2 demonstrates the relationship between MR and MC in determining the profit/returns of a farm in production. The profit optimizing output is Q, where MR=MC (MR intersects MC). At this point, a corn production firm can increase the amount of corn production as long as the added revenue from producing one more bushel/acreage of corn outweighs the added cost of producing one more bushel/acreage.

The above profit/return optimization principle suggested by most economists and used by most firms in production has some limitations. In the real world, it is difficult to know exactly the MR and MC of the last products sold. For instance, it is difficult for firms in production to know the price elasticity of demand for their product which induces the MR. The above concept of profit optimization also depends on how other firms react to the price, especially in a perfectly competitive market, and if demand is inelastic. All this being equal, if only one firm increases price, demand will be elastic, and hence affecting the returns negatively. Therefore, the above profit-maximizing rule may not work in most cases, given that there are several other firms in crop production.

The price, demand, and supply of a crop can be affected by several other factors. These other factors drive the TR and TC of production of corn, thereby affecting the returns. To be able to determine these factors would provide a tremendous leap towards controlling or manipulating the TR and TC and hence optimizing the returns from corn production.

There are at least three variables of interest in crop production, including price (P), quantity (Q), and cost (C). These 3 variables can often determine most of the total cost (TC) and total revenue (TR) of production, and hence the profitability (returns) of the firm into corn production. TC and RT, on the other hand, are determined by several factors. Therefore, the return of production (Rₚ) (Profit $) is a function of several attributable variables of TC and TR. Thus, one may ask what drives the returns of a firm involved in crop production?

In the context outlined above, various systems and methods that implement and making practical use of various data-driven non-linear statistical models is described herein. For example, a model according to the present disclosure can predict the returns from corn production, given the set of values of the significant attributable variables. According to aspects of the embodiments, a real data-driven statistical model of the significant attributable risk factors of corn production in the United States is created. The data consist of the returns from corn production from 1975-2018 in the U.S. There are 25 variables or attributable factors believed to be contributing to the returns from corn production by the United States Department of Agriculture (USDA). The data was filtered to fulfill all the analytical modeling assumptions. The significant attributable variables or risk factors were identified, along with interactions contributing to the returns/profit from corn production.

The data-driven multivariate non-linear statistical model is shown to leverage, in one example, seven significant individual contributable factors and six significant contributable interaction terms that accurately predict the returns from corn production in the U.S. from 1975-2018. The example factors include the opportunity cost of land, fuel, lube and electricity, custom services, the market value of the grain, fertilizer, operating capital, and hired labor. The factors can also include interaction factors, including interactions among fertilizer & price, fertilizer & enterprise size, market value of grain & price, opportunity cost of land & price, fertilizer & variable cost expense, and repairs & operating capital.

The statistical model can accurately predict returns, satisfying assumptions, residual analysis, and goodness-of-fit tests. The identified contributable factors can be ranked according to individual factor percentage of contribution to the returns in descending order of magnitude. In one example, the opportunity cost of land was ranked first, followed by fuel, lube and electricity, custom services, the market value of the grain, fertilizer, etc., and the interaction repair & operating capital ranked last, thirteenth contributable factor. The proposed model performs better compared to other least square models. When applied to the production of corn, the approach described herein offers corn farmers a way to maximize returns from corn production and to further stimulate investor confidence.

The significant attributable factors, including the interactions identified, were ranked based on the percentage of contribution to the returns from corn production, using the coefficient of determination (R²) of the returns. The quality and accuracy of the proposed model was assessed based on the R² along with the R²_{adjusted} statistic, the Akaike information criterion (AIC) of model selection, the prediction error sum of squares (PRESS), the root mean square error (RMSE), the variance inflation factor (VIF), the residual analysis, and comparison of the model with other models.

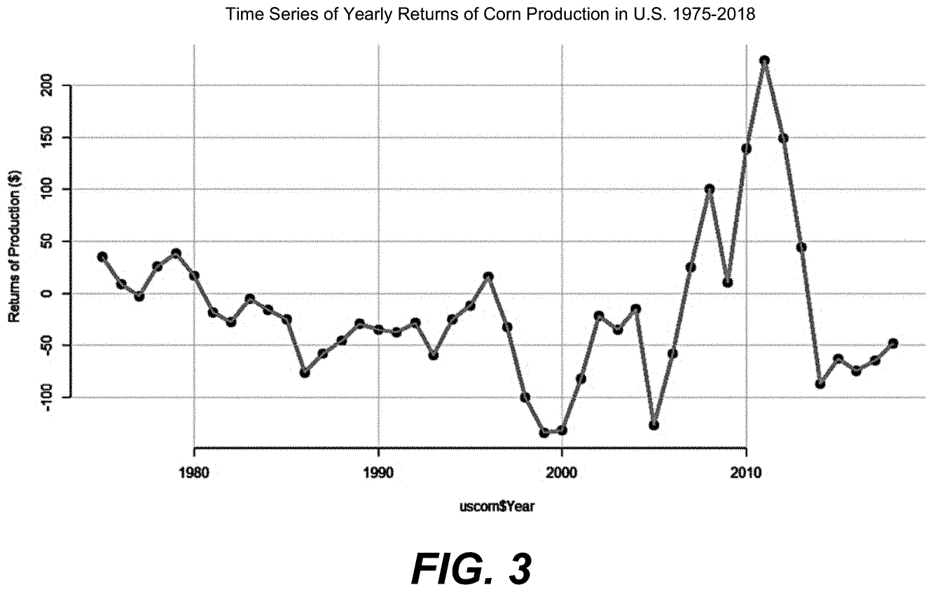

The data used was obtained from the USDA Economic Research Service. The data set consists of 25 attributable variables of the returns from corn production in the USA from 1975 to 2018. FIG. 3 illustrates the non-stationary time series of the returns on corn production in the US. As shown, on the average, the U.S. experienced negative returns on corn production from 1975 to 2006 and positive returns from 2007 to 2013. The U.S. experienced the lowest returns on corn production in 1999 and the greatest returns in 2011. In 2012, the returns continuously decrease from positive returns to negative returns until 2014. Thereafter, the returns have remained negative even though it has been increasing up to the most recent returns in 2018. The decrease in the returns from 2012 was probably due to the effect of the acute drought on the yield and price of corn experienced in 2012.

The returns on corn production were rising after the fall in 2005 until 2009, where there was a decrease before a rise in 2010. The volatility of the returns during this period was probably due to the economic recession in 2007-2008. Table 1 below shows the detailed description of the 25 various variables presumed to be contributing to the returns of the U.S. corn production given by FIG. 3.

TABLE 1
Contributing Variables

| | Variable Name: Contributable |
|---|---|
| Symbol | Variables/Risk Factors |
| R_{P} | Production returns |
| X₁ | Value of primary product grain |
| X₂ | Value of secondary products silage |
| | Operating Cost |
| X₃ | Seed |
| X₄ | Fertilizer |
| X₅ | Chemicals |
| X₆ | Custom services |
| X₇ | Fuel, lube, and electricity |
| X₈ | Repairs |
| X₉ | Purchased irrigation water |
| X₁₀ | Interest on operating capital |
| | Allocated Overhead |
| X₁₁ | Hired labor |
| X₁₂ | Opportunity cost of unpaid labor |
| X₁₃ | Capital recovery of machinery and equipment |
| X₁₄ | Opportunity cost of land |
| X₁₅ | Taxes and insurance |
| X₁₆ | General farm overhead |
| | Supporting Information |
| X₁₇ | Yield (bushels per planted acre) |
| X₁₈ | Price (dollars per bushel at harvest) |
| X₁₉ | Enterprise size (planted acres) |
| X₂₀ | Dryland (percent acres) |
| X₂₁ | Irrigated (percent of acres) |
| | Economic Costs |
| X₂₂ | Variable cash expenses |
| X₂₃ | Capital replacement |
| X₂₄ | Operating Capital |
| X₂₅ | Other non-land capital |

Before carrying out any statistical analysis and modeling, it is important to first perform parametric analysis. Parametric analysis can be used to find the right probability distribution of the response variable for modeling or analyzing. Parametric analysis can also be used to make the correct decisions on whether to transform the response variable, as well as for deciding on the correct choice of transformation. It is a statistical fallacy to employ non-parametric analysis or test if parametric distribution exists. Parametric analysis is more robust and efficient than non-parametric analysis of any kind. However, a non-parametric test is desirable if the given data distribution has no parametric form.

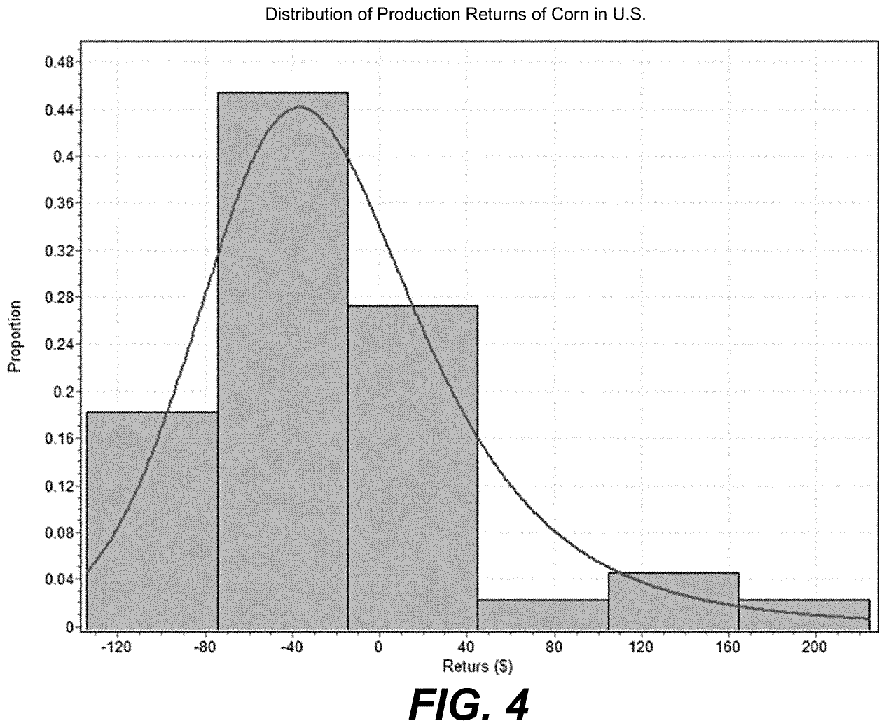

The parametric analysis usually starts with a graphical representation of a histogram and display of descriptive statistics to investigate the probability distribution of the product returns. FIG. 4 illustrates a histogram with returns on corn production in the U.S. from 1975-2018 according to various examples described herein. Table 2, below, shows the descriptive statistics of the product returns.

The descriptive statistics show a mean returns from production of −16.83, which is greater to the median returns from production of −26.28, indicating the production returns is right-skewed, as shown by the histogram, and given by the positive skewed and kurtosis values (i.e., skewed value is 1.17 and kurtosis value is 2.06). The histogram also shows that most of the production of corn returns is between −120 and 40 dollars per planted acre.

TABLE 2
Descriptive Statistics of Corn Production Returns

| Mean | Median | Std Err | Std Dev | Kurtosis | Skewness |
|---|---|---|---|---|---|
| −16.83 | −26.28 | 10.68 | 70.82 | 2.06 | 1.17 |

TABLE 3
Goodness-of-fit Test of the 3P-Lognormal
Distribution of the Survival Time.

| Type of Test | p - value |
|---|---|
| Kolmogorov-Smirnov | 0.86244 |
| Anderson-Darling | 0.54708 |
| Chi-Squared | 0.83494 |

After an assessment of FIG. 4 and Table 2, it was found that the probability distribution that characterizes the probability behavior of the returns from corn production in the U.S. from 1975-2018 follows the three-parameter log-logistic probability distribution. In Table 3, the results of three different goodness-of-fit tests are shown to further assess the validity of the subject probability distribution. The test was based on the Kolmogorov-Smirnov, Anderson-Darling, and Chi-Squared goodness-of-fit tests. The three tests revealed a large p-value, meaning that we do not reject the null hypothesis that the distribution of the returns on corn production follows the 3p-log-logistic probability distribution. Thus, given random production returns, denoted by r, the pdf of the 3p-log-logistic probability distribution is given by:

$$f ( r ; α ; β ; γ ) = \{ \begin{matrix}0 , & if r \leq 0 \\ \frac{α}{β} {( \frac{r - γ}{β} )}^{α - 1} {( 1 + {( \frac{r - γ}{β} )}^{α} )}^{- 2} , & if r > 0\end{matrix} \qquad ( 1 )$$

where α>0 denotes continuous shape parameter, β>0 is the continuous scale parameter, and γ is the continuous location parameter and γ≤r≤+∞. Note that γ=0 gives the two-parameter log-logistic distribution. The maximum likelihood estimation (MLE) method was employed to estimate the parameters α, β, and γ. The MLE method was used because it is more robust than other methods, like the least squares estimation and method of moment methods.

To compute the MLE of the parameters, the derivative of the log-likelihood function was computed and set to zero. For n observation from 3p-log-logistic probability distribution, denoted by r₁, r₂, r₃ . . . , rₙ, the likelihood function can be written as:

$$\begin{matrix}L ( α , β , γ \vert {r}_{i} ) = {\prod }_{i = 1}^{n} f ( {r}_{i} \vert α , β , γ ) \\ = {\prod }_{i = 1}^{n} [ \frac{α}{β} {( \frac{r - γ}{β} )}^{α - 1} {( 1 + {( \frac{r - γ}{β} )}^{α} )}^{- 2} ] \\ = {( \frac{α}{β} )}^{n} {\prod }_{i = 1}^{n} {( \frac{{r}_{i} - γ}{β} )}^{α - 1} {( 1 + {( \frac{{r}_{i} - γ}{β} )}^{α} )}^{- 2} ∀ {r}_{i} > γ .\end{matrix} \qquad ( 2 )$$

The natural log of the likelihood function in equation (2) is taken, given by:

$$ln ℒ = ln ℒ ( α , β , γ \vert {r}_{i} ) = n ln ( α ) - n ln ( β ) + ( α - 1 ) {\sum }_{r = 1}^{n} ln ( \frac{{r}_{i} - γ}{β} ) - 2 {\sum }_{r = 1}^{n} ( 1 + {( \frac{{r}_{i} - γ}{β} )}^{α} ) . \qquad ( 3 )$$

By differentiating equation (3) with respect to α, β, and γ, we have:

$$\begin{matrix}\frac{\partial ln ℒ}{\partial α} = \frac{n}{α} + {\sum }_{r = 1}^{n} ln ( \frac{{r}_{i} - γ}{β} ) - 2 {\sum }_{r = 1}^{n} {ln ( \frac{{r}_{i} - γ}{β} )}^{α} ln ( \frac{{r}_{i} - γ}{β} ) {( 1 + {( \frac{{r}_{i} - γ}{β} )}^{α} )}^{- 1} , & ( 4 ) \\ \frac{\partial ln ℒ}{\partial β} = - \frac{n}{β} - ( α - 1 ) ( \frac{n}{β} ) + 2 \frac{α}{β} {\sum }_{r = 1}^{n} {ln ( \frac{{r}_{i} - γ}{β} )}^{α} {( 1 + {( \frac{{r}_{i} - γ}{β} )}^{α} )}^{- 1} , \\ and & ( 5 ) \\ \frac{\partial ln ℒ}{\partial γ} = ( - \frac{α - 1}{β} ) {\sum }_{r = 1}^{n} {( \frac{{r}_{i} - γ}{β} )}^{- 1} + 2 α {\sum }_{r = 1}^{n} ( \frac{( \frac{{r}_{i} - γ}{β} )}{{r}_{i} - γ} ) {( 1 + {( \frac{{r}_{i} - γ}{β} )}^{α} )}^{- 1} . & ( 6 )\end{matrix}$$

By setting equations (4)-(5) to zero, the MLEs of the parameters of the 3p-log logistic distribution of the production returns given by Table 4 below.

TABLE 4
Parameter Estimates for the Three-Parameter Log Logistic
Probability Distribution of the Returns of Production

| Location (\hat{α}) | Scale (\hat{β}) | Shape (\hat{γ}) |
|---|---|---|
| 6.4565 | 223.59 | −249.91 |

The parameter estimates in Table 4 were substituted into equation (1) to obtain the pdf of the 3p-log-logistic probability distribution of the product returns, given by:

$$f ( r ) = \{ \begin{matrix}0 , & if r \leq 0 \\ 0.0289 {( \frac{r + 249.91}{223.59} )}^{5.4564} {( 1 + {( \frac{r + 249.91}{223.59} )}^{6.4564} )}^{- 2} , & if r > 0\end{matrix} . \qquad ( 7 )$$

After finding the pdf, the cumulative frequency distribution, cdf, can be calculated by taking the integral of the pdf in equation (1). From the cdf, it is possible to estimate the probability that the production firm obtained a certain amount of returns (i.e., F_{R}(r)=P(r≤R)). So, the cdf of the 3p-log-logistic probability distribution of the product returns is given by:

$$\begin{matrix}{F}_{R} ( r ; α , β , γ ) = {\int }_{0}^{r} f ( r ; α , β , γ ) dr \\ = {\int }_{0}^{r} \frac{α}{β} {( \frac{r - γ}{β} )}^{α - 1} ( 1 + {( \frac{r - γ}{β} )}^{α} ) dr \\ = {( 1 + {( \frac{r - γ}{β} )}^{α} )}^{- 1} .\end{matrix} \qquad ( 8 )$$

Substituting the parameter estimates given by Table 4, the cdf is given by:

$${F}_{R} ( r ) = {( 1 + {( \frac{r + 249.91}{223.59} )}^{6.4565} )}^{- 1} . \qquad ( 9 )$$

It is also possible to obtain the reliability of the production returns by deducting the cdf from one. Thus, the probability that the production firm yields beyond a certain amount of returns (\hat{R}(r)=P(r>R)=1−P(r≤R)). Therefore, the reliability of production returns, (r) is given by:

$$\hat{R} ( r ; α , β , γ ) = 1 - {F}_{R} ( r ) = 1 - {( 1 + {( \frac{r + 249.91}{223.59} )}^{6.4565} )}^{- 1} . \qquad ( 10 )$$

After the parametric analysis, the returns from corn production in the U.S. from 1975-2018 was found to be right-skewed and followed the three-parameter log-logistic probability distribution. Now, a multivariate nonstationary statistical regression model was developed for the product returns taking into consideration the 25 attributable factors presumed to be contributing to the returns from corn production in the U.S. given in Table 1. The statistical model was developed based on satisfying the major assumptions of the multivariate linear regression model. Firstly, there should be a linear relationship between the response, r (corn production returns), and the explanatory or attributable variables, given by

rᵢ=τ+Σᵢ₌₁^{k}δᵢXᵢ+Σ_{i≠j=1}^{k}γᵢⱼXᵢXⱼ+∈ᵢ, (11)

where the response variable rᵢ=(r₁, . . . , rₙ)^{T}, τ=(1, . . . , 1)^{T} is the intercept or constant term, βᵢ=(δ₁, . . . , δₖ) T is the coefficient parameter of the attributable factors Xᵢ's, γᵢⱼ is the coefficient parameter of interaction between i^{th} and j^{th} attributable risk factors, ϵᵢ=(ϵ₁, ϵₙ)^{T} denotes the model residual error term, k=25 is the number of attributable factors given by Table 1, and n=43 is the sample size from 1975-2018.

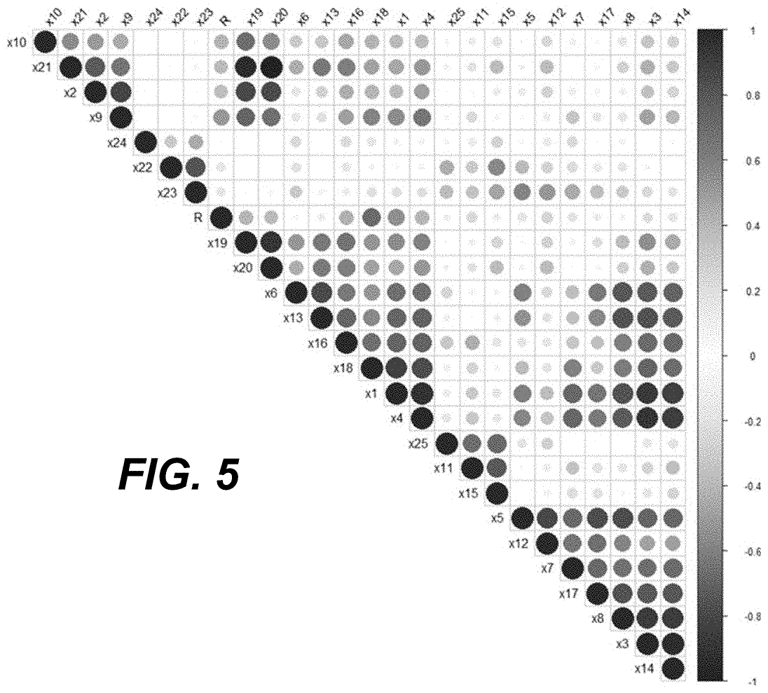

Linearity was assessed by investigating the correlation matrix between the response and the continuous attributable factors given by FIG. 5. The values of the correlation coefficient are bounded between −1 and 1, where −1 is a perfect negative correlation, and 1 is a perfect positive correlation. In the correlation diagram, the dark blue color means a strong positive (+ve) correlation (linear relationship/association) between the two variables, the light blue means moderate +ve correlation, and the white color means little or no correlation.

The deep brown/red depicts strong negative (−ve) correlation and light brown/red color implies moderate −ve correlation. As shown, there is a presence of a moderate to a strong linear relationship between the response and most of the predictors, although some predictors Xᵢ, i=2, 9, 10, 21, showed little or no correlation with the response. It is also clear that there is a very strong correlation between some of the predictors, which can contribute to multicollinearity in a regression model. The problem of linearity would be addressed in the course of the model building process.

Next, the assumption of multivariate normal distribution was investigated. The residuals of a linear regression model is expected to follow the Gaussian normal probability distribution, ϵ˜N(0,1) as n→∞. Discrepancies were noted in the data given by skewed response r (see FIG. 4 and Table 2), lack of linearity between the response and some predictors, and a near-perfect correlation between some predictors. However, we proceeded to fit a linear regression model to the original data to assess other assumptions and how well the 25 attributable variables fit the returns of production.

A Durbin Watson test for autocorrelation shows that the errors are uncorrelated. However, there was a violation of the homoscedasticity of the residual. Another problem encountered from the initial fitted model was an insignificant intercept. Every linear regression model must have a significant intercept to adjust for the linearity between the response and the attributable variables. Not having a significant intercept implies that if all the predictors are zero, then the response variable is zero (i.e., no other variables contribute to the response apart from the given predictors); thus, a highly statistical fallacy.

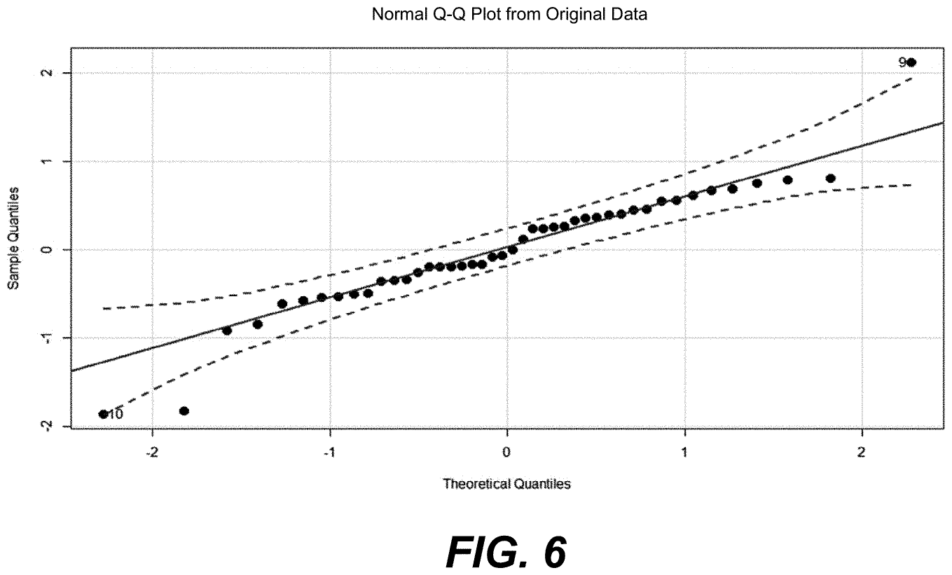

In FIG. 6, the assumption of the Gaussian normal probability distribution of residual errors was tested in the model developed from the original data. Most points fall within the 95% confidence bound, but some points fall outside, which could distort the normality of the errors. We performed a formal test from Shapiro Wilks resulting in a small p−value=0.02096, which implies the violation of normal probability distribution.

Another problem of concern in statistical linear regression modeling is multicollinearity which should be giving close attention. There have been several arguments regarding the concern for multicollinearity if the main objective of the model is for prediction, such as our case, for the prediction of the returns of production. We believe multicollinearity must be closely assessed, because in some cases it may affect the significance of the parameter coefficients of predictors, and distort the efficiency and accuracy of predictions by the statistical model leading to wrong or misleading decisions. However, there are findings and suggestions by some researchers that multicollinearity does not affect the precise prediction and goodness-of-fit of the statistical regression model if it is mainly to make predictions.

After fitting the initial model, the presence of multicollinearity among the predictors using the variance inflation factor (VIF) was tested for. Multicollinearity was found in some of the predictors. However, it is not surprising given the fact that in general, most economic variables tend to be highly correlated. Extremely high multicollinearity should not be overlooked even if the model is mainly for prediction. Given the number of discrepancies encountered, the Johnson transformation was applied to transform the response variable, given by:

$${R}_{T} = γ + η ln ( \frac{r - ϵ}{λ + ϵ - r} ) , \qquad ( 12 )$$

Where R_{T} denotes the transformed response, r is the non-transformed response, and γ, η, ϵ, and λ are the transformation parameters. The Johnson transformation was chosen because it gives a better transformation of the response, Rp, than other forms of transformation like the log transformation and Box-Cox transformation.

After transforming the response variable, the model was refit with all the 25 attributable variables, including their two-way interactions to the transformed response, R_{T}. We then employed the step-by-step backward elimination model selection method to select the significant contributing variables and the interactions. The backward elimination method is a more efficient model selection technique because the resulting mean square error (MSE) is less biased and prevents model overfitting thereby enhancing the model prediction performance.

The method uses the Akaike information criterion, AIC to select the best model with the least AIC. The AIC estimates the relative amount of information loss in the model. Hence, the smaller the AIC the better the fit of the model. Therefore, given that we applied the best form of transformation to the response variable, and adopted the best model selection procedure in selecting the significant attributable variables and interactions, which resulted into the final model with the least AIC given by:

$${R}_{T} = 9.424 {e}^{- 01} + 2.801 {e}^{- 02} {X}_{1} - 8.737 {e}^{- 2} {X}_{4} - 6.225 {e}^{- 02} {X}_{6} - 3.589 {e}^{- 02} {X}_{7} - 1.4 \; 47 {e}^{- 01} {X}_{11} - 5.173 {e}^{- 02} {X}_{14} + 2.082 {e}^{- 01} {X}_{24} - 4.223 {e}^{- 03} {X}_{1} * {X}_{18} + 1.5 \; 05 {e}^{- 02} {X}_{4} * {X}_{18} + 9.248 {e}^{- 05} {X}_{4} * {X}_{19} - 1.238 {e}^{- 02} {X}_{4} * {X}_{22} + 6.1 \; 40 {e}^{- 03} {X}_{14} * {X}_{18} - 9.953 {e}^{- 03} {X}_{8} * {X}_{24} , \qquad ( 13 )$$

along with the transformed response of the returns of production, R_{T}, given by:

$${R}_{T} = - 0.2 \; 680 + 0.9173 ln ( \frac{r - 38.0612}{- 0.0708 - r} ) . \qquad ( 14 )$$

The above final model in equation (13) is the proposed model for the returns from corn production in the United State from 1975-2018 and includes seven individual attributable variables and six interaction terms. Where ‘*’ denotes an interaction between two attributable variables. The model has an R²=0.9822 along with R_{adj}²=0.9745, indicating a very good model.

The coefficient of determination, R² along with the R_{adj}² provides the proportion of variation in the response, R_{T}, explained by the seven identified significant attributable factors and the six interaction terms in equation (13). Therefore, the higher R², the better the goodness-of-fit of the model. But the model must first fulfill all the required assumptions including having little or no multicollinearity. The analytical form of R² and R_{adj}² is given by:

$${R}^{2} = 1 - \frac{S S E}{S S T} , and$$

$${R}_{a d j}^{2} = 1 - \frac{S S E / ( n - p )}{S S T / ( n - 1 )} ,$$

where SST=Σᵢ(rᵢ−r̅)², is called the total sum of squares is the proportional to the sample variance, and equals to the sum of SSR and SSE. SSR=Σᵢ(\hat{r}ᵢ−r̅)² is the regression sum of squares representing the variation explained by the proposed model and SSE=Σᵢ(rᵢ−\hat{r}ᵢ)²=Σᵢeᵢ²; and rᵢ are the corn returns, r̅=1/nΣᵢⁿrᵢ is the estimated corn returns.

Generally, the R² has the problem of increasing by increasing the number of parameters or predictors in the model. So, it is recommended to state R² along with R_{adj}² to adjust for the degree of freedom of the model (R_{adj}²≤R²). Note that n−k denotes the degree of freedom of SSE and n−1 is the degree of freedom of SST. The closer the R_{adj}² to R², the better the good the goodness-of-fit of the model.

To use the proposed model equation (13), we first put the values of the identified attributable variables and the interaction terms into the model, which results in the transformed response or corn returns, R_{T}. To obtain the real value of the corn returns, r, we find the anti-transformation, or the r given by equation (14). Thus, given the values of the identified factors contributing to corn production returns in the proposed model, we can precisely predict the returns to be earned with about 98% degree of accuracy.

Table 5 below shows the ranking order of the statistical significance of each of the identified attributable variables and interaction terms according to the percentage of contribution to the returns from corn production in the U.S. from 1975-2018 based on the R² statistic. The opportunity cost of land is ranked first, and the interaction of repairs and operation capital has been ranked thirteen among the significantly identified attributable factors, as set forth in Table 5 below.

TABLE 5
Table 5: Rank of Contribution of Attributing Factors
to returns from corn production in U.S. 1975-2018

| Rank | Variable | Description | p - value | R² | % Contribution |
|---|---|---|---|---|---|
| 1 | X₁₄ | Opportunity cost of land | 8.52e⁻⁰⁹*** | 0.2116 | 21.54 |
| 2 | X₇ | Fuel, lube and electricity | 8.77e⁻⁰⁵*** | 0.1846 | 18.79 |
| 3 | X₆ | Custom Services | 2.53e⁻⁰⁴*** | 0.1796 | 18.29 |
| 4 | X₁ | Value of primary product | 2.00e⁻¹⁶*** | 0.1538 | 15.66 |
| | | grain | | | |
| 5 | X₄ | Fertilizer | 5.76e⁻⁰⁶*** | 0.141 | 14.36 |
| 6 | X₄ * X₁₈ | Fertilizer & Price | 8.72e⁻⁰⁵*** | 0.0453 | 4.61 |
| 7 | X₂₄ | Operating Capital | 8.41e⁻⁰⁵*** | 0.0197 | 2.01 |
| 8 | X₁₁ | Hired Labor | 8.88e⁻¹⁰*** | 0.0166 | 1.69 |
| 9 | X₄ * X₁₉ | Fertilizer & Enterprise | 8.34e⁻⁰³** | 0.0088 | 0.90 |
| | | Size | | | |
| 10 | X₁ * X₁₈ | Value of primary product | 1.17e⁻⁰⁹*** | 0.0071 | 0.72 |
| | | grain & Price | | | |
| 11 | X₁₄ * X₁₈ | Opportunity cost of land & | 8.72e⁻⁰⁵*** | 0.005 | 0.51 |
| | | Price | | | |
| 12 | X₄ * X₂₂ | Fertilizer & Variable cost | 1.73e⁻⁰²* | 0.0048 | 0.49 |
| | | expenses | | | |
| 13 | X₈ * X₂₄ | Repairs & Operating | 1.19e⁻⁰²* | 0.0043 | 0.44 |
| | | capital | | | |
| Total | | | | 0.9822 | 100 |

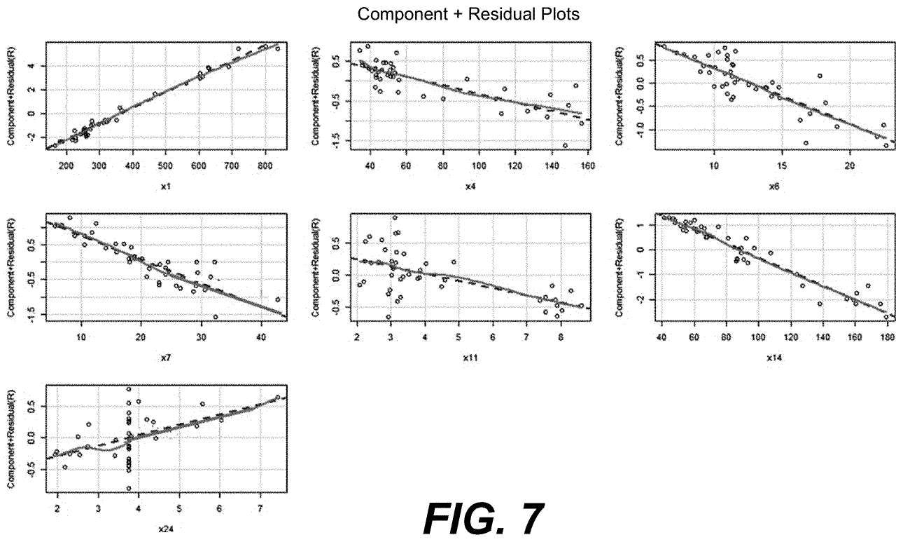

The proposed model given by equation (13) was validated by first satisfying all the key assumptions of the model. First, we tested for linearity between the response variable and the continuous attributable variables using the partial residual plot given by FIG. 7. FIG. 7 shows that there is a well-defined linear relation between the response variable and the individual continuous attributable factors contributing to corn returns. Also, the problem of an insignificant intercept term of the initial model has been resolved. We now have a significant intercept term of the transformed model proposed given by p−value=3.432e⁻⁰³ (i.e., rejecting H₀: τ=0), attesting to the linearity assumption of the model.

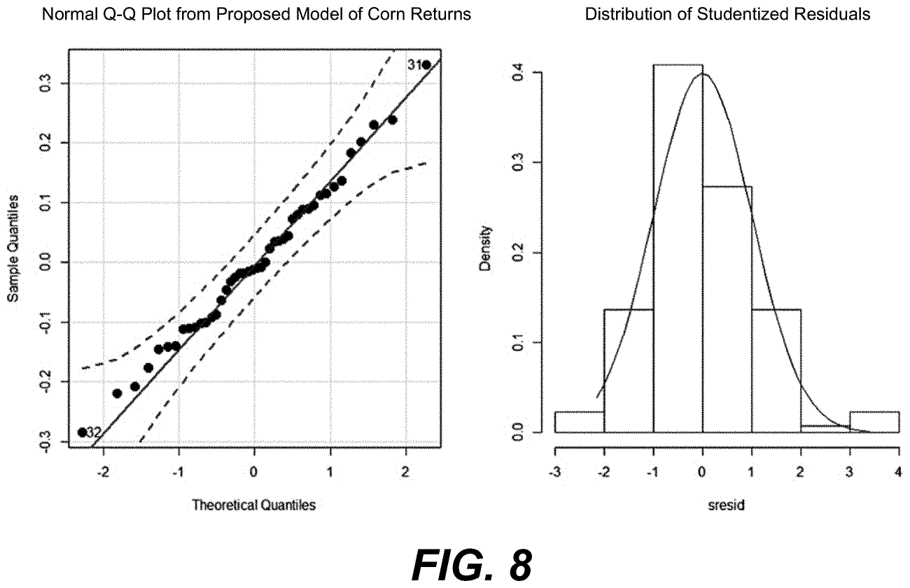

Secondly, we investigated the presence of Gaussian normal probability distribution of the proposed model, given by normal plots in FIG. 8. The first panel is the normal Q-Q plot of residuals with 95% confidence bounds and the second penal is the distribution of the studentized residuals. We can see from both panels that the assumption of the normal probability of the proposed model is well-preserved since all the residual point falls within the 95% bound of the Q-Q plot with no major outlier. We performed a formal test for normality using the Shapiro-Wilk's test, which resulted in a large p−value=0.9759, indicating the proposed model residuals are Gaussian distributed. Thus, further affirming to the evidence of normality given by FIG. 8.

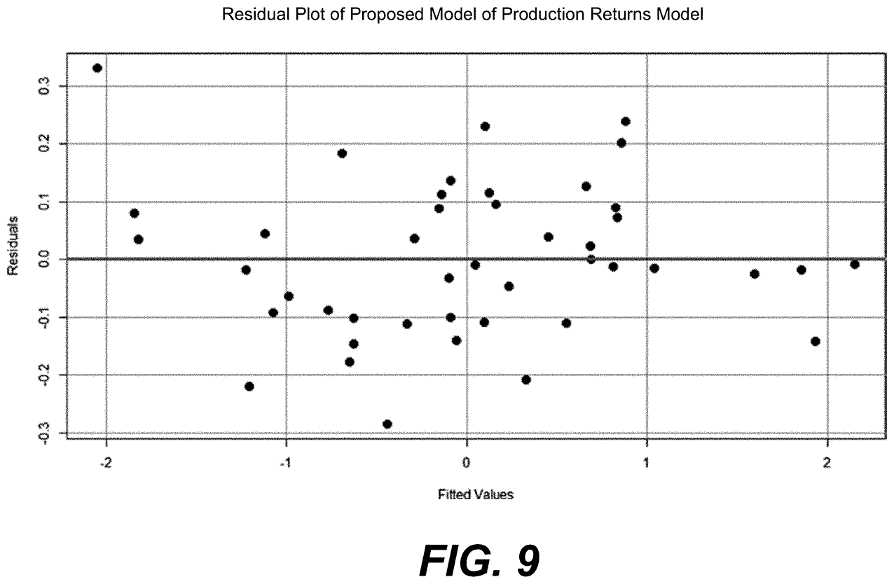

Another key assumption that our proposed model satisfied is homoscedasticity (i.e. the residual errors should have constant variance). We plotted the residuals against fitted values and look for a pattern or trend given by FIG. 9. If there is no pattern or trend, points in the plot are randomly scattered about the zero lines, and no major outlier is an indication of the presence of homoscedasticity.

FIG. 9 reveals that there is evidence of the homoscedasticity of residuals of the proposed model. In a further residual analysis, we found the residuals to have a mean of zero (i.e., ϵ̅=Σᵢ₌₁ⁿeᵢ≈0) and a standard deviation (s=1/(n−1)Σᵢ₌₁ⁿ(ϵᵢ−ϵ̅)²) of 0.7317. Also, the Durbin-Watson test was performed to investigate the presence of autocorrelation among residuals. The test resulted in a large p−value=0.238, indicating that the residuals are uncorrelated.

As stated earlier during the model building, multicollinearity was a problem we encountered. Although some have argued that multicollinearity does not affect the precise prediction of the model. However, we expect a statistical model with very small or no multicollinearity to perform better than models with high multicollinearity. Multicollinearity can cause the mean square error (MSE) to increase drastically and cause some predictors to be statistically insignificant, when in fact they are important in predicting the response. One commonly used technique for handling multicollinearity is by removing the redundant predictor(s) that are highly correlated with the other predictor(s). Very high multicollinearity among predictor variables can lead to overfitting, hence may result in a misleading decision.

The model described herein addresses the problem of multicollinearity after the transformation of the response variable, and the careful selection of the attributable variables based on the stepwise backward elimination model selection procedure, thereby reducing its impact on the precision and accuracy of predictions.

Given that the proposed multivariate nonlinear regression model of corn returns is of high quality, given by R²=0.9822, and validates all the key assumptions, we further measure or validate the quality of the model base on the root mean square error, given by:

$$R MSE = \sqrt{\frac{1}{n} {\sum }_{i = 1}^{n} ( {y}_{i} - {\hat{y}}_{i} )} .$$

The RMSE measures the difference between the predicted value and the observed values. The smaller the RMSE the closer the predicted values are to the observed values, and the more accurate the model prediction. The proposed model has an RMSE of 0.1577, indicating a very good predictive accuracy.

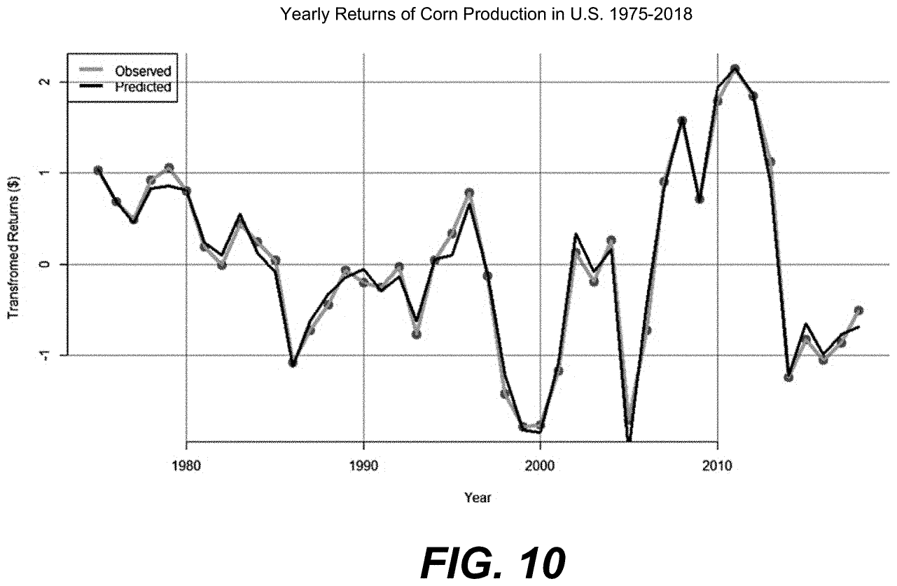

In FIG. 10, the accuracy of prediction by the proposed model was assessed. The model has great accuracy. FIG. 10 shows that the predicted values are very close to the observed values, which explains the high efficiency, precision, and robustness of the proposed model.

We further performed a Kruskal-Wallis test to assess the difference between the observed returns and the predicted returns given by Table 6. The test shows that there is no difference between the two returns, given by the large p-value. Also, there is a very strong correlation between the observed values and the predicted values of 0.9911.

TABLE 6
Kruskal-Wallis rank sum test of the Difference in Observed
Returns and Predicted Return of Corn Production.

| | | Data: list (Observed, |
|---|---|---|
| Type of Test | Corn Returns | Predicted) |
| Kruskal - | Chi-square (\tilde{χ}²) = 6.9644e⁻⁰⁵ | p - value = 0.9933 |
| Wallis | | |

Furthermore, the model was developed using 80% trained data. Then, the model was assessed for prediction accuracy using the remaining 20% of the data. Table 7 shows the prediction of the returns from the 20% test data after we developed the model using the entire data and then 80% train data. A correlation coefficient between the test set and the predicted values revealed 0.958 and 0.976 using the trained model and the entire data model, respectively. The relation between the two model prediction revealed a correlation coefficient of 0.995≈1. This further attests to the high quality, efficiency, predictive accuracy, and precision of the proposed nonlinear analytical model given by equation (13).

TABLE 7
Comparison of Prediction of the Return from Corn
Production Based on Train and Test Method

| | |
|---|---|
| Returns | Predicted Values |

| Observed Values | Entire Data Model | Trained Model |
|---|---|---|
| 1.0255 | 1.0408 | 1.0572 |
| 0.6871 | 0.6874 | 0.6764 |
| −0.0141 | 0.0949 | 0.1099 |
| 0.3312 | 0.1004 | −0.0080 |
| −1.7665 | −1.8461 | −1.8539 |
| 0.1204 | 0.3286 | 0.4018 |
| 1.5682 | 1.5941 | 1.4535 |
| 1.1205 | 0.8815 | 0.8658 |
| −0.8282 | −0.6516 | −0.5541 |

Another strategy employed to assess the quality of the proposed model is comparing it with other least square models. The coefficients of the proposed model for the returns from corn production are estimated using the ordinary least square (OLS) parameter estimation method. One major assumption of OLS is homoscedasticity and the absence of serial correlation. If the assumption is violated (similar to what we initially encountered before the transformation of the response), a transformed version of the OLS, namely, the generalized least square (GLS) is often recommended to give the best linear unbiased estimators provided the other assumptions are satisfied. The GLS regression model can be written as:

\tilde{y}=\tilde{X}β+\tilde{ϵ}, (15)

where \tilde{ϵ}=E⁻¹y denotes the response, \tilde{X}=Σ⁻¹X is the model matrix of predictors, \tilde{ϵ}=Σ⁻¹ E is the model residuals, and β is the GLS estimator given by \hat{β}_{GLS}=(\tilde{X}^{˜T}\tilde{X})⁻¹\tilde{X}^{T}\tilde{y}=(X^{T}V⁻¹X)⁻¹X^{T}V⁻¹y. V is symmetric and positive definite defined as V=ΣΣ^{T}, where Σ is an invertible variance covariance matrix. In a situation where the errors are uncorrelated, but not necessarily homoscedastic, the weighted least square (WLS) is often used to obtain the best unbiased estimators. When V is diagonal, the errors are uncorrelated but may not have equal variance. We can express V=dia(1/w₁, . . . , 1/wₙ), where wᵢ are weights and Σ=\sqrt{1/w₁}, . . . , \sqrt{1/wₙ}, and we can regress \sqrt{wᵢxᵢ} on \sqrt{wᵢyᵢ}.

One of the initial problems in the course of the model building process was an unequal variance of the errors. We applied the Johnson transformation on the response leading to the selection of the final model that satisfies all the assumptions. We compared the quality of our proposed model with the GLS and WLS based on the root mean square error (RMSE) and the Akaike information criteria (AIC) given by Table 7. The proposed model performed much better than the other two methods used.

TABLE 8
Proposed Model Comparison with Other Least Square Models.

| Rank | Method | RMSE | AIC |
|---|---|---|---|
| 1 | Proposed Model | 0.1577 | −24.520 |
| 2 | WLS Model | 0.171 | −18.072 |
| 3 | GLS Model | 0.1759 | −10.823 |

As described above, the production of corn plays a key role in the economy of the United States of America. The U.S. is the world's leading producer of corn, with about 80 million acres (32 million ha) of land exclusively dedicated to corn production. The U.S. agricultural sector is predominantly corn production, playing an essential role in the ethanol production industry, distillery industry, livestock industry, beverage alcohol industry, among others. Approximately 13% of the U.S. annual corn yield is exported to more than 73 different countries across the globe, a report by U.S. grains council. It is therefore imperative to investigate the returns from corn production in the United States.

The amount the corn production industry earns after all revenues and costs is an essential motivation for how they plan their production each year. Therefore, the industry needs to know the key elements or factors contributing to their returns at the end of each production circle. Knowing these key contributors to the returns of the corn production will aid the industry to plan rationally and judiciously to their favor, thereby increasing the product returns. It would further serve as a boost in the U.S. economy of corn production and stiffen its competitiveness in the world's economy of corn production.

A data-driven non-linear statistical regression model was developed to predict the returns of the production of corn in the U.S. The initial model building process accounts for 25 elements or factors presumed by the U.S. department of agriculture (USDA) to be contributing to the returns from corn production in the US. The following questions were asked during the model building process. Are all the 25 factors significant? Are there any significant interacting factors? How much percent is the significant factors contributing? What is the percentage of contribution by each significant factor? How much percent of contribution to the returns is by unknown or confounding factors? These are highly intriguing and essential questions our developed model addressed.

The model building process started by considering all the 25 factors published by the USDA as contributing to the returns from corn production in the US. However, after rigorous and careful investigating analysis we found 7 out of the 25 factors to be statistically significantly contributing individually to the returns from corn production, as well as 6 interaction terms. We utilized the best form of transformation on the skewed returns (i.e. the Johnson transformation) and the best model selection technique (stepwise backward elimination) to identify the significant contributable factors to the corn returns. The final proposed model that precisely and accurately predict the returns from corn production in the U.S. is given by equation (13) in a transformed form. To use the model, we replace the identified predictor variables (i.e. the seven individual attributable factors and the six interaction terms) with real values to predict the transformed returns. We then utilize equation (14) to transform back to the original values of the corn returns.

To justify the goodness-of-fit of the model, the proposed model satisfies all the key assumptions of a linear statistical regression model. It addresses the problem of heteroscedasticity and serial correlation initially encountered. The model has a coefficient of determination, R2 of 98.22%. Thus, 98.22% of the variation in the returns from corn production is explained by the identified seven individual attributable factors and the six interaction terms. In other words, 98.22% of corn production returns are contributed by the identified attributable variables of the proposed model, and the remaining 1.78% is contributed by other unknown or confounding factors.

Multicollinearity may not be considered problematic in a predictive model like ours because it does not affect the precision of prediction of the model. However, multicollinearity can cause some predictors to be insignificant when in fact they are important, causing model overfitting or underfitting. The proposed model lessens the impact of multicollinearity.

We ranked the identified attributable factor and the interactions according to the individual percentage of contribution to the returns from corn production in the US, given by Table 5. In other words, we ranked from the most important contributor to the least contributor of the identified factors to the returns from corn production. It is important to consider the rankings to enable farmers or industries into corn production to allocate resources effectively and efficiently towards maximizing the returns.

The opportunity cost of land was ranked first (21.54%), followed by fuel, lube and electricity (18.78%), custom services (18.29%), the market value of the grain (15.66%), and fertilizer (14.36%) was ranked fifth. The opportunity cost of land is the benefit forgone for trading off the land for cultivation of corn in the U.S. over other economic purposes or use.

Given that all other factors remain constant, the lesser the opportunity cost of land for corn production, the higher the likelihood of the returns. Thus, the expected returns from the production of corn can increase as long as it cost less to cultivate more acres of land for corn production. Also, the investment in corn production would increase if it promises more profit or economic benefits than other alternative economic investments. This is important and useful information we can extract from our model, attesting to the quality of our model. On the contrary, all things being equal, if all the other factors like operating capital, labor, fertilizer, etc., are readily adequately available except the availability of adequate land for the cultivation and expansion of corn production, the amount of returns earned is likely to fall. Given that the U.S. is the world's leading producer and exporter of corn, not trading off the land cultivated for corn production for other economic purposes is a major strategy for increasing the returns. Rather expanding the acreage of cultivated land is essential to keep the U.S. as a continuous world's leader of corn production, thereby increasing the market size of corn, and hence the returns.

Interestingly, the top 5 ranking factors contribute to 88.64% of the returns from corn production in the US. We expected more contribution from operating capital and labor hired ranked seventh and eighth, and contributing 2.01% and 1.69%, respectively, to the returns from corn production. Though operation capital was identified to be highly statistically significantly contributing to the returns from corn production, we expected more in terms of its percentage of contribution given the fact that the growth and expansion of the profitability level of most economic industries or businesses depend largely on the operating capital.

The rank of fuel, lube & electricity as second contributing to 18.79% of the return is not surprising due to the technological advancement in the production of corn. Another intriguing finding by our model is that fertilizer interacts with three different other contributing factors (price, enterprise size, and variable cost expense) not contributing as an individual factor to the returns. Also, price (dollar per bushel harvest) which was not found as a significant contributable individual term interacted significantly with three factors (fertilizer, the value of the grain and opportunity cost of land) that were found as individually contributing to the returns. Similarly, repairs were not individually contributing to the returns, but significantly contribute as it interacted with the operating capital.

Most research in statistical modeling turns to ignore the inclusion of interactions between attributable variables because they are either difficult to find or interpret. However, not including interaction in a model when they significantly contribute to the response variable can distort the robustness and efficiency of the model, thereby weakening the effectiveness, predictive accuracy, and useful information that can be extracted from the model. To have a significant interaction term implies that both attributable variables together have a significant influence on the response variable (the returns), though one or both may or may not be individually significant.

The value of the coefficient of the attributable variables can be interpreted as the change in the response variable (i.e. returns from corn production) brought about by a unit change in the value of the attributable variable. All this being equal, for a positive coefficient, we can maximize the returns/profit by increasing the value of the attributable variable. Whereas, for a negative coefficient, we can maximize the returns by decreasing the value or impact of that attributable variable. For instance, the value of the coefficient for the opportunity cost of land is −0.05173, given by equation (13). This means by holding all the other factors constant, a unit decrease in the opportunity cost of land would increase the returns from corn production by 0.05173, and vice versa. The coefficient of the interaction between fertilizer & price (dollar per bushel harvest) is 0.01505, meaning a unit change in either the fertilizer or price would result in 0.05105 change in the returns.

To further evaluate the quality of the proposed model, we used the model to predict the returns from corn production in the U.S. from 1975-2018 and compared with the observed or original values of the returns, given by FIG. 10. The observed returns are given in green color and the predicted returns are given in black. We can see that the proposed model closely predicted the exact values of the observed returns given by the data. We further computed the correlation coefficient between the two returns to assess the strength of the relationship, resulting in a very strong correlation. We also tested whether there was a difference between the two returns based on the Kruskal-Wallis test, resulting in a very large p-value (no difference), which goes to affirm the result given by FIG. 10 and the correlation coefficient.

The proposed model was compared with other least squares models (i.e. the generalized least squares and the weighted least squares), given by Table 7. The criteria of comparison of the three models were based on the root mean square error (RMSE) and the Akaike information criterion (AIC). A model with least RMSE (captures the remaining amount of unexplained variation in the returns) and least AIC (measures the amount of information not captured by the model) is considered the better. Our proposed model has the least RMSE and AIC, hence the best choice of implementing our proposed model. The finding of the proposed model would serve as a strategy or guide for increasing the returns earned by industries or farmers into corn production in the U.S. and the world at large.

The data-driven multivariate non-linear statistical model identified seven significant individual contributable (risk) factors and six significant contributable interaction terms that accurately predict the returns from corn production in the U.S. from 1975-2018. The identified factors include the opportunity cost of land, fuel, lube and electricity, custom services, the market value of the grain, fertilizer, operating capital, hired labor, and the interaction factors including fertilizer & price, fertilizer & enterprise size, market value of grain & price, opportunity cost of land & price, fertilizer & variable cost expense, and repairs & operating capital. The quality of the proposed model was evaluated by satisfying the model assumptions, and base on very high coefficient of determination (R² along with R²_{adj}) statistic, the least root mean square error (RMSE) statistic, the least Akaike information criterion (AIC) of model selection, and the minimum variance inflation factor (VIF).

The study offers five major usefulness to the economics of corn production. Firstly, given the set of real values of the significant identified contributable factors, we can precisely estimate/predict the returns from corn production with a 98.22% degree of accuracy. Secondly, we identify individual and interaction factors significantly contributing to the returns from corn production. Thirdly, we obtained the ranks of the identified contributable factors to the corn returns from the highest to the least percentage contributor, with the opportunity cost of land appearing as the top contributor to the returns from corn production. Fourthly, we can perform surface response analysis or optimization analysis to identify the value of the attributable factors that are necessary to maximize the returns from corn production. Thus, for a given contributable factor, we can analyze ways to maximize the returns either by increasing or decreasing the impact of the contributable factor, holding the other factors constants. Fifthly, we can create confidence bound with a desirable level or degree of confidence to monitor the returns from corn production. For example, for a 95% confidence interval, if the returns fall below the confidence bound could create investor panic, hence there would be the need for some instantaneous and critical adjustment in the production process through rigorous and careful analysis of the identified contributable factors in the model. On the contrary, if the returns fall within or above the confidence bound could further boost investors' motivation and trust in the economics of corn production.

Finally, the proposed model is cost-effective for the subject area. For corn production firms to maximize their returns/profit, they do not have to spend a huge amount of resources on variables or factors that do not contribute to the returns. Hence, there is no doubt about the tremendous importance the current study brings to improving the economics of corn production in the United States. It would help corn farmers or industries to plan rationally and judiciously towards allocating resources effectively and efficiently to maximize their returns.

The proposed statistical model can be applied to monitor and evaluate the returns/profit in other fields of production. Additionally, the model building process can be applied to develop a similar model for other production sectors or economies. In Appendix A, we discussed how the production firm or industry can utilize our proposed analytical model to maximize the returns of production of corn.

In one summary, the proposed analytical model for the returns from corn production in the U.S. is driven by seven (7) individual contributing factors and six (6) interaction contributing factors. To maximize the returns for corn production, the effect of changes in the coefficients (weights) of the contributing factors on the returns (response variable) were assessed. The following scenarios allow the corn production firm to maximize the returns once they have implemented our production model.

If the coefficients (weights) of the identified contributing risk factor are positive, it means that the production firm can maximize returns by increasing the investment on this contributing risk factor. In other words, more resources should be allocated to the positive contributing risk factor to maximize the returns from the production of corn.

If the coefficients (weights) of the identified contributing risk factor are negative, it means that the production firm can maximize returns by decreasing the investment on such a contributing risk factor. In other words, the production firm can maximize the returns by a reduction in the allocation of resources to such a negative contributing risk factor.

If there are two positive contributing risk factors to the returns from production, with one having a higher coefficient (weight) than the other, then the factor with a larger coefficient contributes more to maximizing the returns by increasing it more than the other. If there are two negative contributing risk factors to the returns from production, the one having a smaller coefficient (weight) than the other, then the risk factor with a smaller coefficient contributes more to decreasing the returns by reducing it more than the other.

In one example, if we have the value of the coefficient (weight) for the opportunity cost of land to be negative, this means that the production firm can maximize the returns if there is a decrease in the opportunity cost of land for corn production. That is, if the firm does not lose more than it gains for utilizing/substituting more land for corn production than other areas of investment, then the returns are expected to be maximized. Also, the coefficient of the interaction between fertilizer & price (dollar per bushel harvest) is positive, meaning increasing the fertilizer & price would result in corn firm maximizing the returns of production.

Hence, the production firm can maximize the returns by considering the combination of the thirteen identified contributing risk factors based on the impact of the coefficients (weights) of the contributing factors that drive the production process.

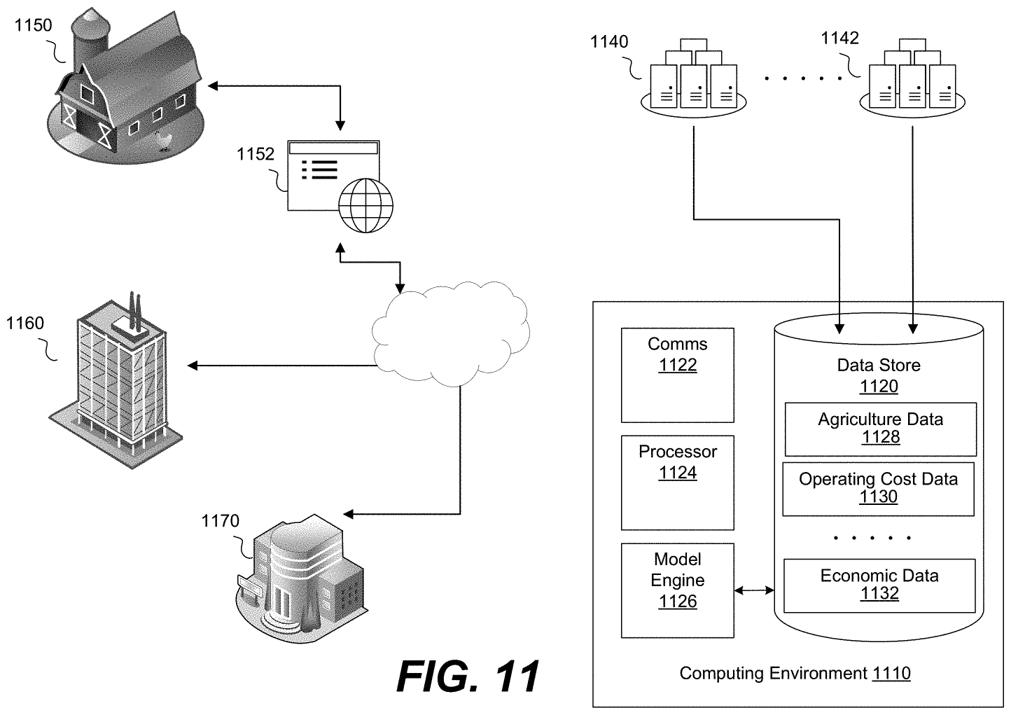

Referring now to FIG. 11, an example embodiment is shown of a system and network implementing various methods discussed herein. A computing environment 1110 comprises a data store 1120, a communications connection 1122, at least one processor 1124, and a model engine 1126. The computing environment 1110 may be implemented via computing resources of a company or institutional network (e.g., local servers, company network) or may be implemented via a cloud computational resource. The communications connection 1122 may be a suitable connection for allowing the computing environment to communicate with remote resources and users, such as any suitable Internet connection or LAN/WAN connection. The computing environment 1110 can be coupled via communications connection 1122 to one or more networks embodied by the Internet, intranets, extranets, wide area networks (WANs), local area networks (LANs), wired networks, wireless (e.g., cellular, 802.11-based (Wi-Fi), Bluetooth, etc.) networks, cable networks, satellite networks, other suitable networks, or any combinations thereof. The computing environment 1110 can communicate with other computing devices and systems using any suitable systems interconnect models and/or protocols. Although not illustrated in FIG. 11, the computing environment 1110 can be coupled to any number of network hosts, such as website servers, file servers, network switches, networked computing resources, databases, data stores, and other network or computing platforms.

Processor 1124 may comprise a one or more processors of local servers, or may be implemented as a virtual processor/virtual machine. Processor 1124 may include or be connected to a memory 1126 that stores software instructions which cause the processor to execute and operate an application that implements the algorithms and techniques described herein. For example, memory 1126 may comprise instructions implementing a model engine for generating, training, refining, and implementing a predictive model as described herein, as well as executing the various communication and operational tasks described herein. The model engine 1126 may be configured to develop and analyze the models described herein. In one example, the model engine 1126 is configured to identify a plurality of contributable factors and a plurality of contributable interaction terms contributing to returns of production. The model engine 1126 can also be configured to rank the plurality of contributable factors from highest to least contributor, perform an optimization analysis to identify a value of attributable factors necessary to maximize the returns, and increase or decrease an impact of at least one of the plurality of contributable factors to evaluate the model, among other functions described herein. Additionally or alternatively, the model engine stored in memory 1126 and implemented by processor 1124 can process data for a given farm, region, season, etc. and provide specific predictions for yield, recommendations for resource expenditure to maximize return, and other outputs of running the models described herein.

Data store 1120 may be a large database comprising data utilized for a variety of purposes, implemented via local network storage or cloud storage. Alternatively, data store 1120 may be represented by connections to remote data services 1140-42, in which case the computing environment simply retrieves data on an as-needed basis from the remote data services 1140-42. Data store 1120 may comprise data representing the key contributing factors to a predictive model as described herein, such as those set forth in TABLE 1, above. The data may include agricultural data 1128 (such as returns, yield, value of primary/secondary products, and information concerning a farm (e.g., size of operation, extent of irrigation, etc); operating cost data 1130; economic data, and other information as described above. In one example, the agriculture data 1128 can include the USDA data described above. In some embodiments, data store 1120 may also collect data from individual users and farms that interact with the system.

The computing environment 1110 can be implemented so as to perform one or more of a variety of functions for different types of users, through implementation of the models and algorithms described above. For example, the system 1110 can provide services to individual farming operations or cooperatives 1150. In such an embodiment, the system 1110 may implement a website or user portal 1152 accessible by the user. The farm, cooperative or other user 1150 may upload certain data regarding the farm, including information from Table 1 or Table 5 above. The user may also indicate relative expenditures on the various inputs to the farming operation, including actual labor expenses, fertilizer costs, irrigation expenses, etc., as well as typical yield and price. Then the system 1110 may process the data using the model engine 1126 to make recommendations for the user regarding which inputs to spend more resources on and which inputs for which resources should be reduced.

For example, if the applied predictive model has a coefficient (weight) of a given identified contributing factor that is positive, this indicates to the user that the farming operation output can maximize returns by increasing investment/expenditure of resources on this contributing factor. Thus, the system 1110 would recommend to the farming operation that it increase resource allocation to the given contributing factor (e.g., more irrigation), to maximize the returns from the production of the crop.

If the coefficient (weight) of an identified contributing factor is negative, this means that the farming operation can maximize its returns by decreasing investment of resources on that factor. In other words, the system 1110 would recommend to the production firm that it can maximize returns by a reduction in the allocation of resources to that factor (e.g., less irrigation, or sell off some land and increase fertilization of remaining land).

If there are two positive contributing factors to the returns from corn production, with one having a higher coefficient (weight) than the other, then the factor with a larger coefficient contributes more to maximizing the returns by increasing it more than the other. If there are two negative contributing factors to the returns from corn production, the one having a smaller coefficient (weight) than the other, then the risk factor with a smaller coefficient contributes more to decreasing the returns by reducing it more than the other.

By way of example, if a predictive model has the value of the coefficient (weight) for the opportunity cost of land to be negative, this means the crop production firm maximizes returns if there is a decrease in the opportunity cost of land for corn production. That is, if the firm does not lose more than it gains for utilizing/substituting more land for corn production than other areas of investment, then the returns are expected to be maximized. Also, the coefficient of the interaction between fertilizer price (dollar per bushel harvest) is positive, meaning increasing the fertilizer price would result in a farming operation maximizing the returns of production.

Hence, a farming operation could maximize returns by considering the combination of the identified contributing risk factors for a given predictive model, based on the impact of the coefficients (weights) of the contributing factors that drive the production process.

In some embodiments, the user 1150 may then provide end-of-season data to the portal 1152, so that the system can obtain additional data for data store 1120 showing actual expenditures on inputs as well as actual production/yield/profit. This data could be used to further refine the predictive model 1126.

Alternatively, or in addition to the foregoing operation, the system 1110 could also provide services to investment firms and other businesses 1160 focused on crop production as a commodity. For example, given various inputs for a given crop production season (either across the US or by geography), a prediction could be made as to yield and profit. In some embodiments, the system 1110 could be utilized to generate a data-driven multivariate non-linear statistical model to accurately predict the returns from specific agriculture production regions, sectors, etc. so as to guide investment in agriculture/commodities or to value farmland real estate by its expected output. In such embodiments, an investment firm may request a prediction for a given crop in a given geography. In such a scenario, the computing environment may first obtain data regarding contributing factors for the given crop in the given geography from remote resources 1140-1142. Then, the computing environment may build and validate a predictive model for that crop/geography, taking into account both linearity and non-linearity of the contributing factors. The model building, selection, and validation, may proceed using the steps described above with respect to a model for predicting corn production returns. Thus, for example, an investment firm 1160 may request a prediction of returns for soybean production in the Midwest for the upcoming season. The computing environment 1110 may then identify (e.g., from published resources, industry coalitions, university publications, and USDA data) appropriate data from which to build the model. The computing environment would then provide to the model estimates of linear and co-linear factors (e.g., estimated prices for the crop, estimated fertilizer costs, etc.), and the computing environment would then provide the resulting prediction and/or the prediction+model to the investment firm 1160.

Additionally, the system 1110 could also be utilized by various governmental agencies, regulatory bodies, industry groups, or the like 1170. For example, a state cooperative or industry association could request that the computing environment 1110 generate a model for wheat production to guide its activities, such as to subsidize or secure optimal pricing for certain inputs for its members (e.g., volume pricing on more fertilizer, or irrigation inputs). In other embodiments, the model may assist governments 1170 in determining the most efficient way to subsidize farming—so as to encourage farming operations to maximize the factors that drive productivity, and minimize factors that are negatively correlated with productivity. Alternatively, the system 1110 could generate a predictive model for a given county, cooperative, state, etc. on a season by season or one-time basis as a service offering.

The computing systems and devices of environment 1110 can be located at a single installation site or distributed among different geographical locations. The computing devices in such networks can also include computing devices that together embody a hosted computing resource, a grid computing resource, and/or other distributed computing arrangement.

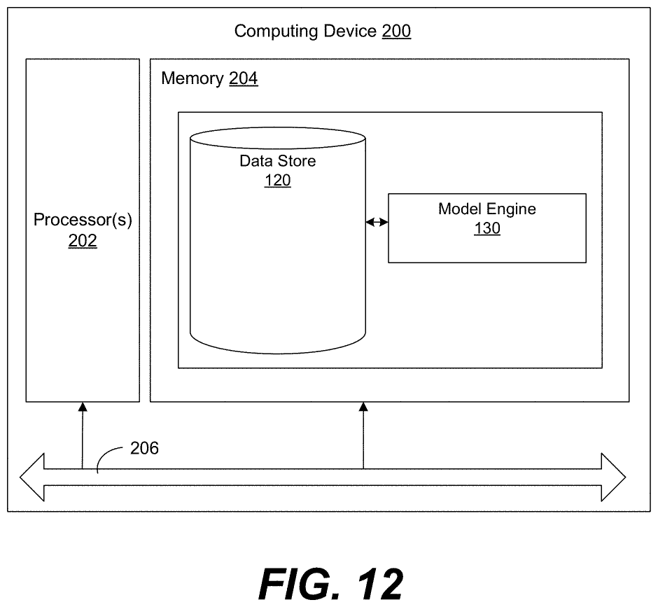

FIG. 12 illustrates an example schematic block diagram of a computing device 200 for the computing environment 110 shown in FIG. 10 according to various embodiments described herein. The computing device 200 includes at least one processing system, for example, having a processor 202 and a memory 204, both of which are electrically and communicatively coupled to a local interface 206. The local interface 206 can be embodied as a data bus with an accompanying address/control bus or other addressing, control, and/or command lines.

In various embodiments, the memory 204 stores data and software or executable-code components executable by the processor 202. For example, the memory 204 can store executable-code components associated with the model engine 130 for execution by the processor 202. The memory 204 can also store data such as that stored in the data store 120, among other data.

It is noted that the memory 204 can store other executable-code components for execution by the processor 202. For example, an operating system can be stored in the memory 204 for execution by the processor 202. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, in various embodiments, the memory 204 stores software for execution by the processor 202. In this respect, the terms “executable” or “for execution” refer to software forms that can ultimately be run or executed by the processor 202, whether in source, object, machine, or other form. Examples of executable programs include, for example, a compiled program that can be translated into a machine code format and loaded into a random access portion of the memory 204 and executed by the processor 202, source code that can be expressed in an object code format and loaded into a random access portion of the memory 204 and executed by the processor 202, or source code that can be interpreted by another executable program to generate instructions in a random access portion of the memory 204 and executed by the processor 202, etc.

An executable program can be stored in any portion or component of the memory 204 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 204 can include both volatile and nonvolatile memory and data storage components. Volatile components are those that do not retain data values upon loss of power. Nonvolatile components are those that retain data upon a loss of power. Thus, the memory 204 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random access memory (SRAM), dynamic random access memory (DRAM), or magnetic random access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

The processor 202 can be embodied as one or more processors 202 and the memory 204 can be embodied as one or more memories 204 that operate in parallel, respectively, or in combination. Thus, the local interface 206 facilitates communication between any two of the multiple processors 202, between any processor 202 and any of the memories 204, or between any two of the memories 204, etc. The local interface 206 can include additional systems designed to coordinate this communication, including, for example, a load balancer that performs load balancing.

As discussed above, model engine 130 can be embodied, at least in part, by software or executable-code components for execution by general purpose hardware. Alternatively the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

Also, any logic or application described herein, including the model engine 130 that are embodied, at least in part, by software or executable-code components, can be embodied or stored in any tangible or non-transitory computer-readable medium or device for execution by an instruction execution system such as a general purpose processor. In this sense, the logic can be embodied as, for example, software or executable-code components that can be fetched from the computer-readable medium and executed by the instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

At least the following is claimed:

1. A system for analyzing agricultural production, comprising:
a communications connection;
at least one processor coupled to the communications connection; and
a memory device having stored thereon a set of computer-readable instructions which, when executed by the at least one processor, cause the at least one processor to:
receive a request from a user for a predictive analysis of agricultural production of a given crop for a given geography;
process agricultural data, operational cost data, and economic data for the given crop and given geography according to a model for agricultural production;
return to the user a prediction of production and at least one recommendation for increasing or decreasing resources invested in at least one contributing factor to the production prediction, the contributing factors comprising at least one of:
opportunity cost of land;
cost of fuel, lube and electricity;
cost of custom services;
value of primary crop product;
cost of fertilizer;
combination of fertilizer cost and crop price value of operating capital;
cost of hired labor;
combination of fertilizer cost and farm enterprise size;
combination of value of primary crop product and price;
combination of opportunity cost of land and price;
combination of fertilizer cost and variable cost expenses; and
combination of cost of repairs and value of operating capital.

2. The system of claim 1 wherein the model for agricultural production defined by:
$${R}_{T} = 9.424 {e}^{- 01} + 2.801 {e}^{- 02} {X}_{1} - 8.737 {e}^{- 2} {X}_{4} - 6.225 {e}^{- 02} {X}_{6} - 3.589 {e}^{- 02} {X}_{7} - 1.447 {e}^{- 01} {X}_{11} - 5.173 {e}^{- 02} {X}_{14} + 2.082 {e}^{- 01} {X}_{24} - 4.223 {e}^{- 03} {X}_{1} * {X}_{18} + 1.5 \; 05 {e}^{- 02} {X}_{4} * {X}_{18} + 9.248 {e}^{- 05} {X}_{4} * {X}_{19} - 1.238 {e}^{- 02} {X}_{4} * {X}_{22} + 6.1 \; 40 {e}^{- 03} {X}_{14} * {X}_{18} - 9.953 {e}^{- 03} {X}_{8} * {X}_{24} ,$$
wherein X₁ represents value of primary product grain; X₄ represents a fertilizer value; X₆ represents value of custom services; X₇ represents value of fuel, lube, and electricity; X₁₁ represents value of hired labor; X₁₄ represents opportunity cost of land; X₂₄ represents value of operating capital; X₁₈ represents price of the crop; X₁₉ represents enterprise size; X₂₂ represents variable cost expenses; and X₈ represents value of repairs.

3. The system of claim 1 wherein the request from a user comprises a request for analysis of an individual farm enterprise, and the recommendation is based upon contributing factors localized to a location of the individual farm enterprise.

4. The system of claim 3 wherein the communications connection comprises a user portal, and is configured to receive data from the farm enterprise indicative of returns based on implementation of the recommendation for the farm enterprise; and further wherein the data indicative of returns is provided to the processor to refine the model.

5. The system of claim 4 wherein the communications connection is configured to receive data indicative of current values for the farm enterprise for cost inputs to the model, including: cost of fuel, cost of fertilizer, cost of hired labor, and costs for customer services.

6. The system of claim 5 wherein the instructions further cause the processor to request from remote resources data for the farm enterprise's geography relating to economic inputs to the model, including: value of primary product grain, crop price, and value of land.

7. A method for optimizing operations of a farming enterprise, comprising:
identifying first value data for a plurality of isolated factors contributing to crop production returns;
identifying second value data for a plurality of interaction factors contributing to crop production returns;
sending the first value data and the second value data to a remote computing environment;
causing an optimization analysis to be performed by the remote computing environment using the first value data and the second value data, to identify at least one optimization factor to be increased or decreased in order to maximize the crop production returns; and
increasing or decreasing the farming enterprise's allocation of resources to the at least one optimization factor.

8. The method of claim 7, wherein the plurality of isolated factors comprises opportunity cost of land; cost of fuel, lube, and electricity; cost of custom services; market value of grain; cost of fertilizer; value of operating capital; and cost of hired labor.

9. The method of claim 7, wherein the interaction factors comprise interactions among cost fertilizer and crop price; cost of fertilizer and enterprise size; market value of grain and crop price; opportunity cost of land and crop price; cost of fertilizer and variable cost expense; and cost of repairs and operating capital.

10. The method of claim 10, wherein the optimization analysis is performed using a model defined by:
R_{T}=9.424e⁻⁰¹+2.801e⁻⁰²X₁−8.737e⁻²X₄−6.225e⁻⁰²X₆−3.589e⁻⁰²X₇−1.447e⁻⁰¹X₁₁−5.173e⁻⁰²X₁₄+2.082e⁻⁰¹X₂₄−4.223e⁻⁰³X₁*X₁₈+1.505e⁻⁰²X₄*X₁₈+9.248e⁻⁰⁵X₄*X₁₉1.238e⁻⁰²X₄*X₂₂+6.140e⁻⁰³X₁₄*X₁₈−9.953e⁻⁰³X₈*X₂₄,
wherein X₁ represents value of primary product grain; X₄ represents a fertilizer value; X₆ represents value of custom services; X₇ represents value of fuel, lube, and electricity; X₁₁ represents value of hired labor; X₁₄ represents opportunity cost of land; X₂₄ represents value of operating capital; X₁₈ represents price of the crop; X₁₉ represents enterprise size; X₂₂ represents variable cost expenses; and X₈ represents value of repairs.

11. A system for generating predictions of crop returns, comprising:
a communications connection;
at least one processor coupled to the communications connection; and
a memory device having stored thereon a set of computer-readable instructions which, when executed by the at least one processor, cause the at least one processor to:
identify a set of initial factors contributing to returns from production of a given crop in a given geography;
obtain data for the initial factors and historic returns from production of the given crop in the given geography, and assess statistical reliability of the production returns data;
assess linearity of correlation between each of the set of initial factors and historic returns;
assess multicollinearity of each of the set of initial factors and historic returns;
transform the historic returns data, and fit the initial factors to the transformed historic returns data, to employ a step-by-step backward elimination model selection, to select significant contributing factors and interactions of factors to form a predictive model;
using the predictive model, process agricultural data, operational cost data, and economic data for the given crop for a given farming enterprise growing the given crop within the given geography; and
return to a user a prediction of production returns for the given crop under the farming enterprise's supplied data.

12. The method of claim 11 wherein transforming the historic returns data comprises applying a Johnson transformation to the historic returns data as a response variable, given by:
$${R}_{T} = γ + η ln ( \frac{r - ϵ}{λ + ϵ - r} ) ,$$
